(19) United States
(12) Patent Application Publication
(10) Pub. No.: US 2012/0014864 A1
(43) Pub. Date: Jan. 19, 2012

(54) HYBRID FOAM/LOW-PRESSURE AUTOTHERMAL REFORMER

(76) Inventors: Roger R. Lesieur, Enfield, CT (US); Antonio M. Vincitore, South Windsor, CT (US)

(21) Appl. No.: 12/452,708

(22) PCT Filed: Jul. 20, 2007
(86) PCT No.: PCT/US07/16511

§ 371 Date: Jan. 19, 2010

(51) Int. Cl. C01B 3/38; B01J 35/04

(52) U.S. Cl. 423/652; 423/648.1; 422/222; 423/651

(57) ABSTRACT

An autothermal reformer (103) includes a long section of unified foil or honeycomb catalyst bed (120) and a much shorter mixing and spreading section (102) of monolithic, open cell foam which mixes and spreads the components of mixture to be reformed. A fuel/steam mixture (A) passes through a heat exchange tube (44), and air (B) passes through a heat exchange tube (46), both tubes being heated by the exothermic catalytic reaction. The air, fuel and steam are mixed in a plurality of tubes (40) passing through a manifold (32), and thence into the monolithic, open cell foam mixing and spreading section (102). The shorter section may or may not be catalycized.

### TECHNICAL FIELD

An autothermal reformer has a very short mixing and distributing section (such as between about 3% and about 30% of the length of the catalytic bed, which comprises a high surface area, monolithic, open cell foam, the catalytic bed comprising low-pressure drop unified foil or honeycomb. The short, open cell foam section is adequate to thoroughly mix and completely distribute the incoming steam and/or fuel gas and air across the entire cross section of the bed; the monolithic foil or honeycomb bed having low pressure drop and being effective in the reforming process.

### BACKGROUND ART

Fuel cell power plants include fuel gas steam reformers which are operable to catalytically convert a fuel, such as natural gas or heavier hydrocarbons, into the primary constituents of hydrogen and carbon oxides. The conversion involves passing a mixture of the fuel gas and steam through a catalytic bed which is heated to a reforming temperature by heat transfer through metal walls. The required catalyst temperature varies depending upon the fuel being reformed. Catalysts used in hydrocarbon fuel reformers are typically nickel, and for low temperature methanol reformers, are typically copper or copper-zinc.

Autothermal reformers are often used when higher operating temperatures are required for the reforming process. In an autothermal reformer, the reaction gases are heated by burning excess fuel with air added within the reaction bed to the fuel and steam mixture so that the remaining fuel-steam mixture is raised to the temperature necessary for the fuel processing reaction. This eliminates the need for heat transfer through very high temperature metal walls. Typically, catalyst temperatures in an autothermal reformer are in the range of about 1,400° F. (760° C.) to about 1,800° F. (980° C.); however, for oxygenated fuels the reaction temperatures are in the range of about 500° F. (260° C.) to about 800° F. (430° C.). In order to transfer heat to the catalyst at the temperatures required for reformation of non-oxidized fuels, wall temperatures in a conventional reformer would be around 2,000° F. (1090° C.).

In U.S. Pat. No. 6,746,650, the catalyst bed structure is formed from a monolithic open cell foam core which is provided with a porous high surface area wash coat layer onto which the catalyst layer is deposited, as described in U.S. Pat. No. 6,140,266. The wash coat may be alumina, lanthanum-stabilized alumina, silica-alumina, silica, ceria, silicon carbide, or another high surface ceramic material. The choice of wash coat will depend on the operating parameters of the specific catalyst bed.

The interconnected open cells of the monolithic foam are impregnated with a catalyst either after the wash coat is deposited or simultaneously with the wash coat. The foam monolith may have an entry end portion which is coated with a catalyst consisting of lanthanum-promoted alumina, calcium oxide, and an iron oxide catalyst which can also be treated with a small amount of platinum, palladium or rhodium for improved low temperature fuel gas ignition. As an alternative configuration, the entry end may include a catalyst of platinum, palladium or rhodium without the iron oxide catalyst. The remainder of the foam monolith may be provided with a copper or copper-zinc catalyst, or with such noble metal catalysts such as platinum, palladium, rhodium, or the like, depending on the fuel. The open cell foam, once wash coated, provides the high surface area of catalysts needed to properly process the fuel gas. The open cell foam also provides an enhanced mixing and distribution gas flow pattern for gases passing through the monolith since the gases will flow both laterally and longitudinally through the structure. However, the tortuous passages in the ceramic foam result in high pressure drop of up to several psi.

Many fuel cell power plant designs operate at or near atmospheric pressure, making it difficult to accommodate the pressure drop in an autothermal reformer having the ceramic foam catalyst bed of the aforementioned patents.

### SUMMARY

A monolithic, open cell foam core not only mixes the incoming steam and/or air and fuel gases together very effectively, that is, achieving complete mixture in a very short longitudinal distance along the path of mass flow of the gases, the monolithic, open cell foam core also distributes the mixture laterally, over a very large cross sectional area within a short longitudinal distance. Stated alternatively, it is now known that the monolithic, open cell foam core promotes full mixture and cross sectional distribution of the gases in as little as several percent of the total length of an autothermal reformer.

An autothermal reformer suitable for use with fuel cell power plants operating at or near atmospheric pressures is achieved by having most of the autothermal reformer employ a catalyst bed having a very low pressure drop, such as a unitized foil or honeycomb catalyst support or bed, preceded by a very short section of monolithic, open cell foam which is sufficiently short that the pressure drop thereacross is insignificant, but the mixing and distribution of which is adequate for the reformation process within the low pressure catalyst bed. The length of the open cell foam is selected to be just enough for thorough mixing and complete spreading.

Other variations will become apparent in the light of the following detailed description of exemplary embodiments, as illustrated in the accompanying drawings.

### BRIEF DESCRIPTION OF THE DRAWINGS

FIG. 1 is a perspective view of one form of a monolithic, open cell foam which may be used in the hybrid reformer.

FIG. 2 is an axial, side elevation cross-section of an exemplary hybrid autothermal reformer assembly having a short section of monolithic, open cell foam, the bulk of the catalytic bed comprising monolithic foil.

FIG. 3 is a sectional view of the reformer assembly taken along the line 3-3 of FIG. 2.

### MODE(S) OF IMPLEMENTATION

In FIG. 1, catalyst bed 102 is a monolithic, open cell foam component which includes a lattice network of tendrils 104 which form a network of open cells 106 which are interconnected in the X, Y and Z directions within the bed 102. The interconnected open cells 106 are operable to form an enhanced fuel gas mixing and distribution flow path from an inlet side 108 to an outlet side 110 of the bed 102. The open cells 106 and the tendrils 104 also provide a very large catalyzable surface area in the bed 102. The core of the foam catalyst bed 102 can be formed from aluminum, stainless steel, an aluminum-steel alloy, silicon carbide, nickel alloys, carbon, graphite, a ceramic, or like materials. Monolithic cores of the type described above can be obtained from ERG Energy Research and Generation, Inc. of Oakland, Calif., which cores are sold under the registered trademark “DUOCEL”, or from Porvair Advanced Materials, Inc. of Hendersonville, N.C. Additional details may be had with reference to the aforementioned U.S. Pat. No. 6,140,266.

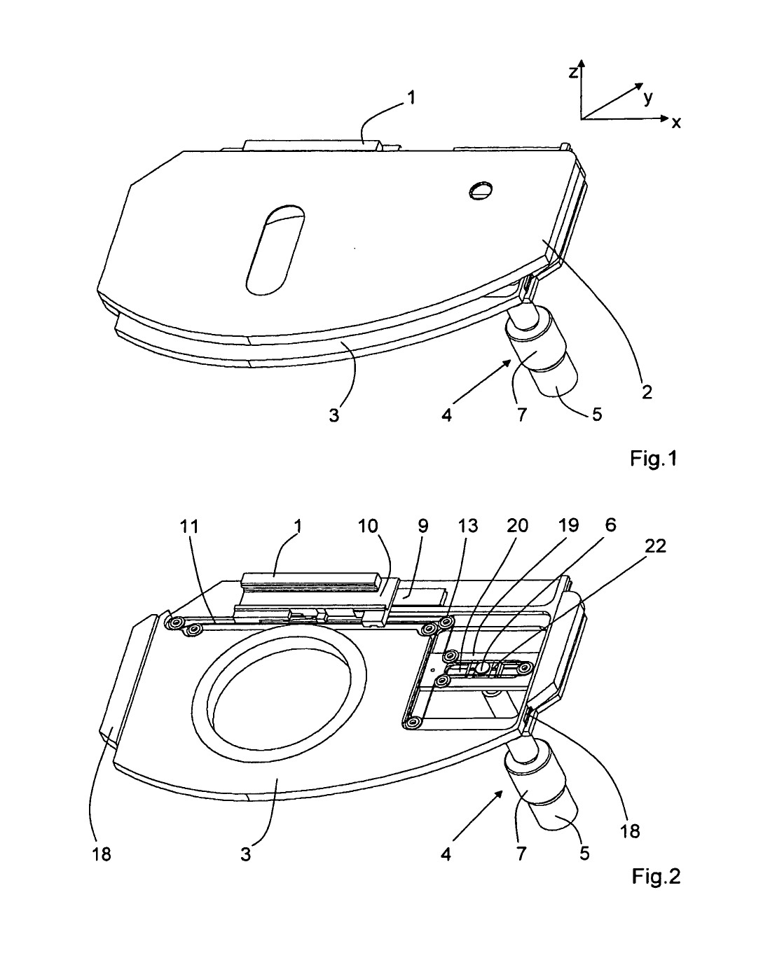

FIG. 2 is a somewhat schematic sectional view of an exemplary autothermal reformer assembly 103 which includes a mixing and spreading section comprising a short section of the monolithic, open cell foam 102 of FIG. 1. The autothermal reformer assembly 103 also includes a very long section of unitized catalyst support 120, having an inlet 113 at the junction with the foam 102.

In the illustrated embodiment, the support 120 is a unitized foil catalyst bed. This is formed from thin sheets of steel, one sheet being flat, and an adjacent corrugated sheet being affixed thereto. The sheets are given a wash coat of high surface area alumina, and then impregnated with a suitable catalyst. Alternatively, the catalyst may be applied in the wash coat with the alumina. The various catalysts which may be utilized are described hereinbefore and in the aforementioned patents. The flat sheet with the corrugated sheet attached thereto, with catalysts disposed over all of the surfaces of both sheets, are then rolled up so as to form a cylindrical bed (as seen in FIG. 2), much in the fashion of rolling up a window shade.

Alternatively, a honeycomb support can be formed directly by extrusion of a ceramic “mud”, which is then fired at a high temperature to sinter the ceramic to a solid monolithic honeycomb support for the catalyst.

The catalyst beds 102, 120 are contained in an open-ended cylindrical inner housing 12. An intermediate cylindrical housing 16 surrounds the inner housing 12 and forms an inner annular gas flow path 18 for gas exiting from the catalyst bed 120. An outer cylindrical housing 20 forms the outermost wall of the reformer assembly 103. The outer cylindrical housing 20 combines with the intermediate cylindrical housing 16 to form an outer annular gas flow path chamber 22 in the assembly 103. The bottom of the assembly 103 is closed by a lower annular wall 24, and the upper end of the assembly 103 is closed by an upper annular wall 26 and a manifold 28. The inner housing 12 can be insulated to prevent heat loss to the stream in the annulus 18, and to keep housing 12 from reaching the high catalyst temperature.

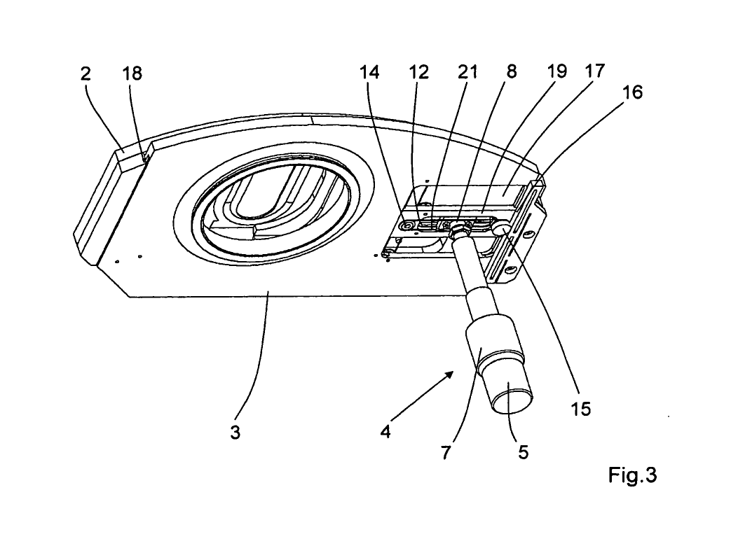

The manifold 28 includes an upper fuel/steam-inlet chamber 30 and a lower air-inlet chamber 32. The chambers 30 and 32 are separated by a plate 34 having a plurality of passages 36 formed therein (FIG. 3). A similar plate 38 forms the lower wall of the air-inlet chamber 32. A plurality of fuel passage tubes 40 interconnect the two plates 34 and 38, the tubes 40 including perforations 42 which admit air from the chamber 32 into the gas stream flowing through the tubes 40. The air and fuel/steam streams thus intermingle in the tubes 40 before entering the inlet end 108 of the catalyst bed 102.

The fuel/steam mixture enters the reformer assembly 103 via a heat exchange tube 44, as indicated by arrow A. The temperature of the incoming fuel/steam mixture is a minimum of about 300° F. (150° C.) to about 450° F. (230° C.) depending on the fuel vaporization requirement. The air stream enters the reformer assembly 3 via a heat exchange tube 46, as indicated by arrow B. The temperature of the entering air stream is similar to the temperature of the fuel/steam stream. The heat exchange tubes 44 and 46 can be finned tubes, or can be covered with a foam material similar to that shown in FIG. 1 above. The fins or foam are operable to enhance heat transfer to the gas streams in the tubes 44 and 46.

The heat exchange tubes 44 and 46 both spiral around the cylindrical housing 16 through the chamber 22 so that heat is transferred to the fuel/steam mixture stream and to the air stream from the reformer exhaust stream, as is described in more detail hereinafter. Alternatively, the spiral tubes could be replaced by other heat exchanger mechanisms which are capable of transferring energy from the processed exhaust gas stream to the inlet streams. By the time that the fuel/steam mixture stream enters the inlet chamber 30, its temperature will have been raised to a temperature in the range of about 300° F. (150° C.) to about 1200° F. (480° C.), and by the time that the air stream enters the inlet chamber 32, its temperature will have been elevated to the same temperature range. The fuel/steam mixture exits the inlet chamber 30 via the tubes 40. The air stream (arrow B) enters the tubes 40 by way of the openings 42 and intermingles with the gas/steam mixture in the tubes 40. Thus, the proper admixture of air, steam and fuel will be formed in the tubes 40 and will flow therefrom into the inlet end 108 of the catalyst bed 102. The temperature of the air, steam and fuel admixture will be in the range of about 300° F. (150° C.) to about 1200° F. (480° C.), depending on the fuel being processed.

The catalyst bed 120 may be divided into different catalyst zones which include an inlet zone 48 and a subsequent zone 50. The inlet zone 48 is typically wash coated with alumina and then catalyzed with calcium oxide, iron oxide, and/or platinum, palladium or rhodium, so as to increase the temperature of the gas mixture by combustion or partial oxidation of the incoming fuel/steam/air mixture to a temperature in the range of about 700° F. (370° C.) to about 1900° F. (1040° C.), depending on whether the fuel is methanol or a heavy fuel such as gasoline.

The subsequent catalyst zone 50 is provided with an underlying wash coat of alumina which is overlain by a copper and/or zinc catalyst or noble metal catalyst. The catalyst zone 50 is operative to convert the fuel/steam and air mixture into a hydrogen-enriched fuel stream which may be further processed to be made suitable for use in a fuel cell power plant. The bed 120 is catalyzed in the following manner. A wash coated porous, high surface area alumina primer is applied to all outer and interstitial surfaces in the bed 120 which are to be catalyzed. The alumina wash coat can be applied to the bed 120 by dipping the bed 120 into a wash coat solution, or by spraying the wash coat solution onto the bed 120. The wash coated bed 120 is then heat treated so as to form the alumina layer on the core. The catalyst layer is then applied to the alumina surfaces of the bed 120. If so desired, the alumina coating and catalyzing steps can be performed concurrently. Similar steps may be used for other wash coating materials.

The reformed fuel stream exits from the catalyst bed 120 at a temperature of about 500° F. (260° C.) to about 600° F. (315° C.) for methanol and 1200° F. (480° C.) to 1500° F. (815° C.) for heavy hydrocarbon fuels, and then passes upwardly through the annulus 18 per arrows C. The exit gas from the reformer passes up through the annulus 18 in order to provide heat to the heat exchange tubes 44 and 46 of the incoming fuel/steam mixture and the incoming air stream. The reformed gas continues to supply heat to these tubes as it travels through the chamber 22, as indicated by arrows D, to an exit passage 52. The reformed gas continues to supply heat to the tubes 44, 46 as it travels through the chamber 22 to the exit passage 52. The reformed gas stream exits the assembly 103 through the passage 52 at a temperature of about 350° F. (175° C.) to about 1200° F. (480° C.), depending on the fuel, whereupon it is further cooled and then passes to a shift converter, a selective CO oxidizer, and the fuel cell power plant assembly.

As noted in FIG. 3, the fuel/steam and air transfer and mixing tubes 40 are arranged in an array through the plate 34 in the manifold 28 which optimizes flow distribution. The number of tubes 40 can be varied as necessary, depending on the desired flow rate of the reformed fuel through the assembly 103, and the desired air-fuel-steam mixing ratios.

The monolithic, open cell foam catalyst bed may be coated with a reforming catalyst, similar to that used in the inlet zone 48, whenever fuels like gasoline, diesel or kerosene are being reformed, in order to prevent carbon formation on its surfaces (coking).

The short section of monolithic, open cell foam catalyst bed 102 may be used with a long, low pressure bed other than the illustrated monolithic foil, such as the aforementioned conventional, suitably catalyzed honeycomb.

The open cell foam 102 will have a length (in the flow direction) which is no greater than that necessary for the gases at the inlet to become thoroughly mixed, and for the mixture to be dispersed completely across the cross section of the unitized catalyst support 120. The length of the open cell foam 102 may be between about 3% and about 30% of the length of the unitized catalyst support 120, or more likely, it may be between about 5% and about 10% of the length of the support 120. The length of monolithic open cell foam required for adequate mixing and distribution may be determined empirically for any particular design of reformer, number of mixing tubes 40, and the velocity through those tubes, and any given fuel mixture.

1. A method comprising:
reforming a fuel to provide hydrogen-rich reformate gas in a reformer (103) having a catalyst supported (120) by other than open cell foam, and having an inlet with a cross section;
characterized by:
mixing and spreading, across substantially the entire cross section of said inlet, components of (i) fuel, steam and air or (ii) fuel and air in a section of monolithic, open cell foam (102).

2. A method according to claim 1 further characterized in that said mixing and spreading step comprises mixing and spreading said mixture in open cell foam (102) which has a length in the direction of flow which is about that which is necessary (a) to substantially thoroughly mix said mixture and (b) to spread said mixture across substantially the entire cross section of said catalyst.

3. A method according to claim 1 further characterized in that said mixing and spreading step comprises mixing and spreading said mixture in open cell foam (102) selected from aluminum, stainless steel, an aluminum-steel alloy, silicon carbide, nickel alloys, carbon, graphite and a ceramic.

4. A method of reforming hydrocarbon fuel or alcohol according to claim 1.

5. A method of reforming fuel in an autothermal reformer (103) according to claim 1.

6. A method of reforming fuel in a reformer having a catalyst supported (120) by unified foil or ceramic honeycomb according to claim 1.

7. A method according to claim 1 further characterized in that said mixing and spreading step comprises-mixing and spreading said mixture in open cell foam (102) catalycized with the same catalyst as said catalyst bed (120).

8. A reformer (103), comprising:
a catalyst bed (120) having an inlet (113) with a cross section, configured of other than monolithic open cell foam, catalycized to process fuel mixtures to produce a hydrogen-containing reformate gas;
characterized by:
a monolithic, open cell foam mixing and spreading section (102) connected (30-42) to receive a flow of components of a mixture (i) to be mixed, (ii) to be spread across said cross section, and (iii) to be reformed in said catalyst bed, said catalyst bed connected to receive outflow of said mixing and spreading section.

9. A reformer according to claim 8 further characterized in that:
said mixing and spreading section (102) has a length in the direction of flow which is about that which is necessary (a) to substantially thoroughly mix said components and (b) to spread said resulting mixture across substantially the entire cross section of the inlet to said catalyst bed.

10. An autothermal reformer according to claim 8.

11. A reformer according to claim 8 further characterized in that:
said open cell foam (102) is catalycized with the same catalyst as said catalyst bed (120).

12. A reformer according to claim 8 further characterized in that:
said catalyst bed (120) is configured of unified foil or honeycomb.

13. A reformer comprising:
a catalyst supported (120) by other than monolithic, open cell foam having a first length along the direction of flow of mixture to be reformed;
characterized by:
a monolithic, open cell foam mixing and spreading section (102) connected (30-42) to receive components of said mixture to be reformed and connected (113) to flow said mixture to said catalyst bed, said mixing and spreading section having a second length which is between about 3% and about 50% of said first length.

14. A reformer according to claim 13 further characterized in that:
said second length is between about 5% and about 15% of said first length.

15. A reformer according to claim 13 further characterized in that:
said open cell foam (102) is catalycized with the same catalyst as said catalyst bed (120).

16. An autothermal reformer according to claim 13.

17. A method comprising:
a reformer having a catalyst supported (120), by other than monolithic, open cell foam, and having a first length along the direction of flow of mixture to be reformed;
receiving components of said mixture to be reformed in a monolithic, open cell foam mixing and spreading section (102), connected (113) to flow said mixture to said catalyst bed, said mixing and spreading section having a second length which is between about 3% and about 50% of said first length.

18. A method according to claim 17 further characterized in that:
said second length is between about 5% and about 15% of said first length.
